(19) United States
(12) Patent Application Publication
(10) Pub. No.: US 2009/0232998 A1
(43) Pub. Date: Sep. 17, 2009

(54) NIP COATING DEVICE AND METHOD

(75) Inventor: Ferdinand Krebs, Wabern (CH)

Correspondence Address: RATNERPRESTIA, P.O. BOX 980, VALLEY FORGE, PA, 19482, US

(73) Assignee: POLYTYPE CONVERTING S.A., Fribourg (CH)

(21) Appl. No.: 11/994,080

(22) PCT Filed: Jun. 30, 2006
(86) PCT No.: PCT/EP06/06390

§ 371 Date: Mar. 18, 2009

(30) Foreign Application Priority Data
Jun. 30, 2005 (DE) 10 2005 030 945.3

(51) Int. Cl. B05D 1/28; B05C 1/08

(52) U.S. Cl. 427/428.2; 118/255

(57) ABSTRACT

A device for applying a liquid coating material onto a moving web-shaped substrate material, comprising application rollers rotatably mounted in a roller frame and forming a NIP roller gap for dosing the coating material; and a supply chamber for the coating material, which is vertically arranged adjacent to the rollers.

The invention relates to a method and a device for continuously coating an advancing web material with a viscous medium, in particular a solvent-based lacquer, or with an adhesive solution. The invention relates in particular to a device which is suitable for so-called “flowing on”.

DE 25 07 116 discloses a device and a method comprising a horizontally arranged multiple-roller applicator and a co-operating horizontal supply container, wherein the applied medium is first dosed in a vertical NIP roller gap with the horizontally arranged, co-operating, rotatable rollers.

Another coating device, with a vertically arranged NIP roller gap, is known from DE 39 06 070, FIG. 3.

A means for applying a coating liquid onto a moving web comprising an application roller which is rotatably arranged in a frame, a vertically arranged supply chamber for the coating medium which co-operates with it, and a dosing blade is known from DE 28 20 249.

With the increasing demands on coating speeds, foaming in the applicator, in particular in the supply area of the coating medium, has proven a disadvantage in the applicators known from the prior art. Foaming is caused by air bubbles due to the increased circumferential velocity of the application rollers in the applied medium. Foaming on the coating substrate is disadvantageously visible as air bubbles. Foaming is also a hindrance in regulating the volume flow for the applied medium. Other disadvantages of foaming are described in DE 28 20 249.

It is an object of the invention to provide a device and a method for uniformly applying a viscous applied medium, in particular solvent-based lacquers or adhesives, onto a moving substrate material, using which foaming due to air bubbles is prevented.

The device in accordance with the invention consists of a supply chamber for the medium to be applied and at least two rollers, preferably exactly two rollers, having rotational axes which run substantially in parallel, wherein the rollers extend into the supply chamber and form a roller gap, preferably a NIP roller gap, between at least two adjacent rollers. The NIP roller gap differs from a normal roller gap in that the size of the gap, formed by the smallest distance between the two surfaces of two rollers, can be set. This can for example be achieved by one of the rollers or two or more rollers being adjustable, such that the distance between the rotational axes of the rollers is variable.

At least one of the rollers, and preferably all of the rollers, are rotary-driven, wherein the rollers can have a common drive or can each be driven individually, for example by an electric motor, whereby each of the at least two rollers can rotate at a different speed to each of the others. The rotational direction of the rollers can be in the same direction, however it is preferred if the two rollers which together form the NIP roller gap rotate in opposite directions, wherein the rotational directions are selected such that both the rollers forming the NIP roller gap transport the coating material from a supply chamber into the NIP roller gap, wherein preferably, one of the two rollers is a rubber roller and the other is a steel roller. In principle, however, the possibility is not to be excluded that both the rollers are rubber rollers or steel rollers or other suitable rollers.

In a preferred embodiment, the rotational axes of the rollers lie on a straight line which is largely perpendicular to the web to be coated, in the area in which the web is coated. This results in the supply chamber being arranged to the side of the rollers, and the NIP roller gap being aligned largely horizontally.

The upright, vertically arranged supply chamber is formed by the rollers on one longitudinal side, i.e. the side which extends in the direction of the straight line on which the rotational axes of the rollers lie, and on the other longitudinal side by a rear wall made for example of metal. The chamber also comprises side walls, and walls forming the upper and lower side of the chamber. The longitudinal extension of the supply chamber is shorter than the distance between the point on the uppermost roller at which the straight line formed by the rotational axes of the rollers breaches them in the upward direction, and the point on the lowermost roller at which the straight line formed by the rotational axes breaches them in the downward direction, i.e. in other words, the uppermost roller and the lowermost roller are beyond the supply chamber as viewed in the longitudinal direction. In a less preferred embodiment, the supply container can also protrude beyond the upper and/or lower roller or can have the same vertical extension as the entirety of the rollers. The straight line formed by the rotational axes can of course also exhibit any angle of inclination to the substrate web in the area of coating; in an extreme case, it can be arranged horizontally. In the latter case, the NIP roller gap would then be a vertical gap and the supply chamber would be arranged above or below the rollers.

The lateral extent of the supply chamber, by which is meant the extent in the direction of the longitudinal axis of the rollers, can be set. Thus, substrate material of different widths can be coated and/or strips of coating material of different widths can be applied onto a substrate material. If a plurality of strips of coating material are to be applied adjacently onto the substrate material, then either a plurality of narrow supply chambers can be arranged adjacently along the cylinders, or the supply chamber can be sub-divided in the transverse direction, i.e. along the longitudinal axis of the rollers, into areas which optionally can all or individually be loaded with coating material. In order to be sealed, the side walls of the supply chamber can for example comprise elastic seals which seal them in the area of the rollers. The supply chamber is sealed in the direction of the longitudinal axis of the rollers at the uppermost and lowermost roller, also for example by means of elastic seals or blades.

The coating material is fed into the supply chamber through at least one inlet and is transported out of the supply chamber again through at least one overflow, wherein the coating material is preferably fed continuously in an amount which is above the amount needed for coating. If, as is preferred, the inlet or inlets are then attached at or near the lower end of the supply chamber, while the outlet or outlets are attached at the uppermost end of the supply chamber, the supply chamber is always filled with coating material, which reduces the risk of air bubbles in the coating material. The coating material flowing through the overflow is preferably collected and re-fed into the process.

In order to transfer the coating material onto the substrate material, the uppermost of the application rollers forms another NIP roller gap with a roller, for example a rubber roller, which transports the substrate material through the machine. The substrate material passes through this other NIP roller gap and is coated with the coating material by the application roller. Between the NIP roller gap for dosing the coating material and the other NIP roller gap, a blade can be placed on the side of the uppermost application roller facing away from the supply chamber, in order to reliably prevent air bubbles in the coating material.

The supply chamber can be attached on one or other side of the application rollers, in accordance with whether the coating is a reverse rotation coating or a concurrent rotation coating. A reverse rotation coating is understood to mean a coating of the substrate material in which the application roller rotates counter to the web movement, while in the case of concurrent rotation coating, the application roller rotates in the direction of the web movement.

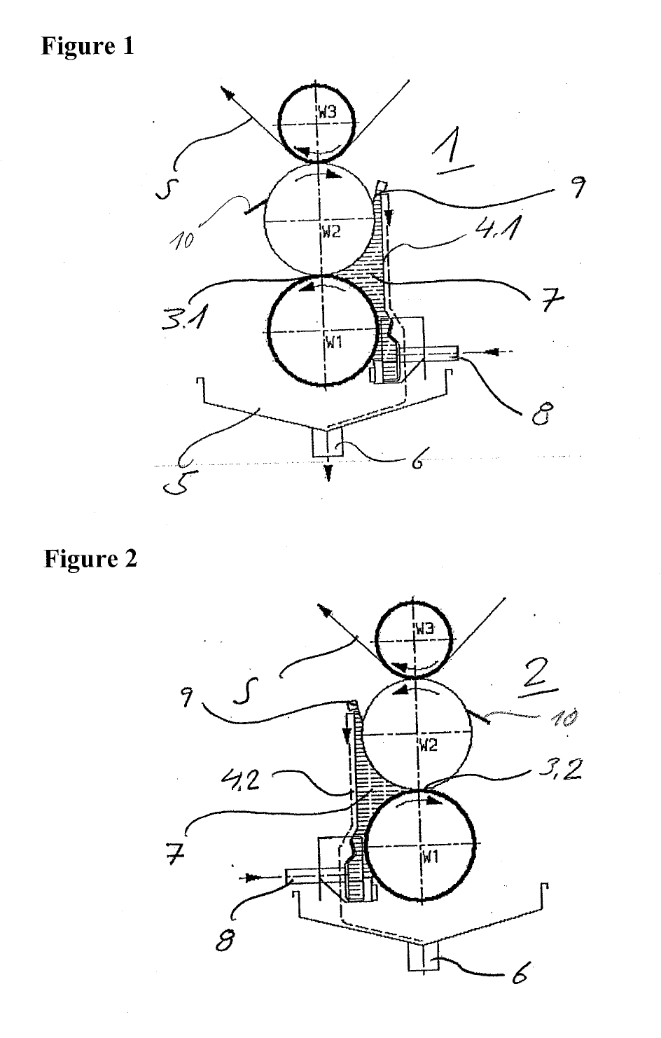

The object is solved using an applicator (1; 2) comprising a horizontal NIP roller gap (3.1; 3.2) for dosing the applied medium, and a co-operating, vertically arranged supply chamber (4.1; 4.2) in accordance with FIGS. 1; 2. The horizontal NIP roller gap (3.1; 3.2) is formed between the application rollers (W1) and (W2). In accordance with a reverse rotation coating (FIG. 1) or concurrent rotation coating (FIG. 2), the vertical supply chamber can be arranged on one or the other side of the application rollers (W1, W2). An application weight of between 8 and 30 g/m² wet in the reverse rotation method (FIG. 1, rotational direction of the roller W2 counter to the web movement), and between 3 and 12 g/m² wet in the concurrent rotation method (FIG. 2) is provided, in accordance with the properties of the applied medium. The circumferential velocity of the rubber roller (W3) corresponds to the web velocity of up to about 450 m/min. The circumferential velocity of the steel roller (W2) can be regulated from about 30% to 200% of the web velocity, and the circumferential velocity of the rubber roller (W1) from about 5% to 50% of the web velocity. For fine-tuning the applied amount, the circumferential velocities of the rollers (W1, W2) can be adjusted with respect to each other. The feed volume of the applied medium to the supply chamber is about 1.5 times the consumption volume.

The applied medium is fed into the supply chamber approximately horizontally via a suitable feed conduit at the lower end of the supply chamber. The applied medium flows vertically in the supply chamber from bottom to top.

The coating medium is transferred onto the web (S) in the NIP roller gap between the roller (W2) and the roller (W3).

The application rollers (W1, W2), which rotate in opposite directions, transport the applied medium horizontally into the NIP roller gap. In order to set the applied amount, the rollers (W1, W2) can be vertically adjusted with respect to each other. The distance from the rear vertical closing wall of the supply chamber to the application rollers (W1, W2) and to the side walls can be horizontally adjusted, such that the volume in the supply chamber can be changed. In order to seal the supply chamber (4.1, 4.2), a suitable blade, for example a knife blade, is provided at the lower end, in co-operation with the roller (W1). The supply chamber is closed laterally, approximately corresponding to the coating width, by side walls in cooperation with the rollers (W1, W2). For maintenance work on the applicator (1), the entire supply chamber can be moved away from the rollers (W1, W2) using suitable means.

An overflow (9) is formed at the upper end of the supply chamber (4.1, 4.2), via which the volume flow which has been fed in excess can flow off onto the rear wall of the supply chamber. A collecting device (5) comprising an outlet (6) below the applicator (1; 2) collects the applied medium which has been fed in excess. In order to protect the applied medium, an outer cover can be arranged over the vertical supply chamber wall.

A blade (10) is placed onto the application roller (W2) which helps to form the gap for the substrate material (S), on the side facing away from the supply chamber (4.1, 4.2), in order to even more reliably prevent air bubbles in the coating material (7).

1-10. (canceled)

11. A device for applying a liquid coating material onto a moving substrate comprising:
application rollers rotatably mounted in a roller frame and forming a NIP roller gap for dosing the coating material; and
a supply chamber for the coating material which is vertically arranged adjacent to the application rollers.

12. The device according to claim 11, wherein the application rollers are immersed in the coating material contained in the supply chamber and an immersed surface area of each application roller extends from the NIP roller gap over an arc angle of at least 40°.

13. The device according to claim 11, wherein the application rollers are immersed in the coating material contained in the supply chamber and an immersed surface area of each application roller extends from the NIP roller gap over an arc angle of at least 60°.

14. The device according to claim 11, wherein the application rollers are immersed in the coating material contained in the supply chamber and an immersed surface area of each application roller extends from the NIP roller gap over an arc angle of at least 90°.

15. The device according to claim 11, wherein the supply chamber comprises an inlet for the coating material which is arranged lower than the NIP roller gap.

16. The device according to claim 11, wherein the supply chamber comprises an inlet for the coating material in a lower partial area of the supply chamber.

17. The device according to claim 11, wherein the supply chamber comprises an outlet for the coating material which is arranged higher than the NIP roller gap.

18. The device according to claim 17, wherein the outlet is in an upper end of the supply chamber.

19. The device according to claim 17, wherein the outlet comprises an overflow.

20. The device according to claim 11, wherein a vertical flow of the coating material is maintained in the supply chamber during application of the coating material.

21. The device according to claim 20, wherein the vertical flow of the coating material is maintained between a lower inlet and an upper outlet.

22. The device according to claim 11, further comprising a guiding roller which guides the substrate, wherein the guiding roller forms a gap with one of the application rollers and is arranged at least substantially vertically above said application roller.

23. The device according to claim 11, wherein the substrate is a web-shaped substrate material.

24. A device for applying a liquid coating onto a moving substrate comprising:
a roller frame;
application rollers rotatably mounted in the roller frame and forming a NIP roller gap for dosing the coating material; and
a supply chamber for the coating material, wherein the application rollers protrude into the supply chamber such that the coating material fills an intermediate space that remains between the application rollers and extends into the NIP roller gap.

25. A method for applying a liquid coating material onto a substrate, comprising:
moving the substrate through a device comprising application rollers that form a NIP roller gap, the application rollers are immersed far enough into the coating material that the coating material fills an intermediate space which remains between the application rollers cohesively up to the NIP roller gap; and
applying the coating material onto the substrate material by at least one of the application rollers.
